(19) United States
(12) Patent Application Publication
(10) Pub. No.: US 2010/0083828 A1
(43) Pub. Date: Apr. 8, 2010

(54) REMOVAL OF CARBON DIOXIDE FROM FLUE GAS STREAMS USING MIXED AMMONIUM/ALKALI SOLUTIONS

(75) Inventors: Joanna Duncan, Springvale, ME (US); Christopher McLarnon, Exeter, NH (US); Francis Alix, Rye, NH (US)

Correspondence Address: Nikolas J. Uhlir;Powerspan Corp., 100 International Drive, SUITE 200, PORTSMOUTH, NH, 03801, US

(73) Assignee: POWERSPAN CORP., Portsmouth, NH (US)

(21) Appl. No.: 12/597,529

(22) PCT Filed: May 1, 2008
(86) PCT No.: PCT/US08/62174

§ 371 Date: Oct. 26, 2009

Related U.S. Application Data
(60) Provisional application No. 60/915,288, filed on May 1, 2007.

(51) Int. Cl. B01D 53/78; B01D 53/30; B03C 3/155; B01D 53/14; B03C 3/16; B01D 53/62

(52) U.S. Cl. 95/13; 95/227; 95/214; 95/68; 95/209; 96/27

(57) ABSTRACT

A process for removing carbon dioxide from a gas stream by scrubbing the carbon dioxide from the gas stream with a mixture of ammonium and alkali carbonates such as sodium carbonate and/or potassium carbonate. Using the mixed alkali carbonate solution as the CO₂ scrubbing solution offers the opportunity for both low regeneration energy and low ammonia volatility while still maintaining a high rate of CO₂ hydration.

### TECHNICAL FIELD

The invention relates to methods and apparatuses for removing carbon dioxide from a flue gas stream.

### BACKGROUND ART

Basic scrubbing of CO₂ is a process that has been known for many years. Patents describe the ability of ammonia, sodium, and potassium solutions to absorb CO₂ at least to some degree. They suggest that NH₃ is more efficient than the potassium and sodium counterparts and have lower regeneration costs. The problem with ammonia solutions is the volatility of ammonia and the potential for ammonia loss to occur during both the absorption and regeneration steps of the process. What is needed, therefore, is a CO₂ scrubbing solution with low regeneration energy and low ammonia volatility.

### SUMMARY

The invention is a process that satisfies the need for a CO₂ scrubbing solution with low regeneration energy and low ammonia volatility. The invention is a process for removing CO₂ from a gas stream by scrubbing the CO₂ from the gas stream with a mixture of ammonium and sodium carbonate or ammonium and potassium carbonate. A mixed alkali solution takes advantage of the benefits of using ammonia for high rates of CO₂ hydration and of using sodium or potassium for achieving high capacities. To obtain the same scrubbing rates in a single alkali solution would require solutions with high ammonia vapor pressures or low capacities for CO₂. Using a mixture of ammonium and other alkali carbonates such as sodium and/or potassium as the CO₂ scrubbing solution offers the opportunity for both low regeneration energy and low ammonia volatility while still maintaining a high rate of CO₂ hydration. These and other features, aspects, and advantages of the present invention will become better understood with regard to the following description, claims, and accompanying drawing.

### DESCRIPTION OF DRAWINGS

FIG. 1 is a schematic of a process according to the present invention.

### DETAILED DESCRIPTION

The invention is a process for removing CO₂ from a gas stream by scrubbing the CO₂ from the gas stream with a mixture of ammonium and other alkali carbonate compounds such as sodium carbonate and/or potassium carbonate.

The Absorption/Regeneration Equation that is operative in this process is:

CO₃²⁻+CO₂+H₂O<->2HCO₃⁻ (1)

In the absorption process, CO₂ gas and water vapor are absorbed into a carbonate solution forming bicarbonate. It is expected that the hydration of CO₂ is the rate limiting step of the process. Both hydroxide and ammonia increase the rate of hydration of CO₂. However, increasing the pH of the solution to a regime where hydroxide is present for CO₂ scrubbing would require a large addition of base such as NaOH or KOH. Operating an ammonium carbonate solution under conditions where the CO₂ hydration is fast and the capacity of CO₂ is large enough to be economical brings the process into a regime where the ammonia vapor pressure is large and difficult to manage. Therefore, a mixture of ammonia with another alkali such as potassium or sodium is used to maximize the absorption capacity of the solution for CO₂, maintain the high rate of CO₂ hydration during the scrubbing process, and minimize the ammonia volatility and release from the absorption process. Once the absorption solution is saturated with CO₂ it must be regenerated. The solution is regenerated by heating the solution to release CO₂ as shown as the reverse of reaction 1.

The regeneration energy is very important to the economics of the process. Evaluation of the reaction energies suggests the energy consumption for equation (1) is the same whether Na⁺, K⁺ or NH₄⁺ is used. However, to operate the Na⁺ or K⁺ system in a regime for fast CO₂ absorption would also require the regeneration of the base. Since both NaOH and KOH are strong bases, the energy consumption for recovery is likely to limit the applicability for the Na⁺ and K⁺ analogs. The #Hᵣₓₙ=−44.5 and −57.5 kJ/mol for the dissolution of NaOH and KOH respectively. However, with NH₃ present in solution, the high rate of CO₂ hydration is still available and since NH₃ is a weak base the dissolution energy is 5 kJ/mol allowing regeneration of ammonia in the mixed alkali solution to be economically feasible in the process.

What is required is a solution with low regeneration energy and low ammonia volatility. Using a mixture of ammonium and other alkali carbonates as the CO₂ scrubbing solution offers the opportunity for both low regeneration energy and low ammonia volatility while still maintaining a high rate of CO₂ hydration.

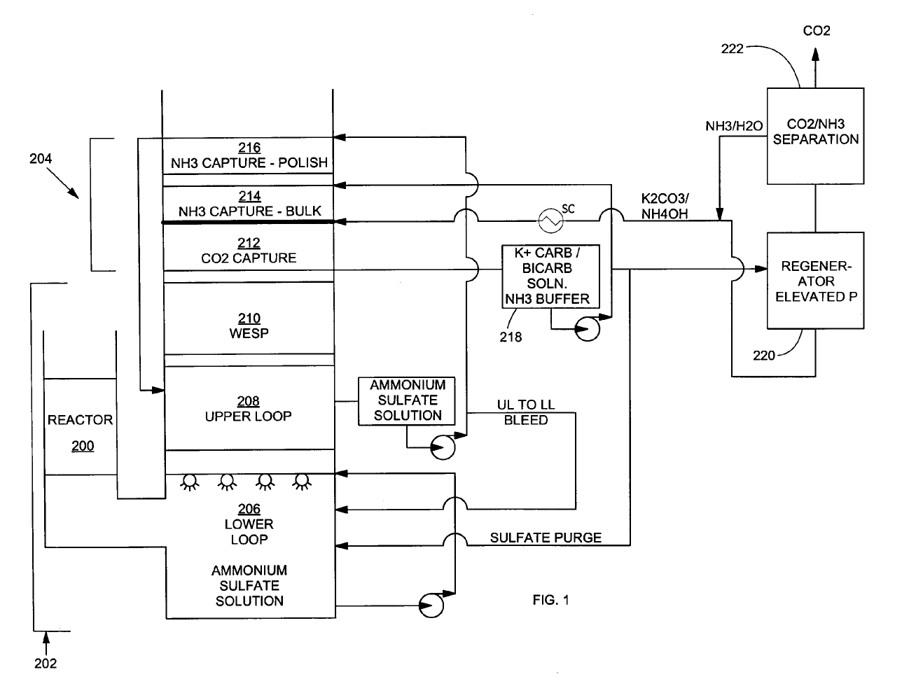

Turning to FIG. 1, the scrubbing tower is broken into two sections, 202 and 204. For more efficient removal of CO₂, the SO₂ and NOₓ are removed from the flue gas stream 202. The preferred method of SO₂ and NOₓ removal is through an ammonia scrubbing solution similar to that described in U.S. Pat. Nos. 6,605,263 and 6,936,231 where flue gas is cooled to saturation, 206 prior to entering a mass transfer section. In the mass transfer section 208 the SO₂ and NOₓ are removed using a pH controlled ammonium sulfate solution. Finally, aerosols or particulates are removed using a device such as a wet electrostatic precipitator 210. Once SO₂ and NOₓ are removed from the flue gas stream, the carbon dioxide is captured in the CO₂ capture section 212.

The solution used in the CO₂ capture section is a mixture of potassium and ammonium carbonate or sodium and ammonium carbonate 218. The solution goes through the CO₂ mass transfer section 212, removing CO₂ from the flue gas stream and producing a carbonate/bicarbonate solution. The mixed alkali bicarbonate solution is then regenerated by heating at an elevated temperature 220 releasing CO₂, NH₃, and H₂ O. The CO₂ is separated from the NH₃ and H₂O 222 and is a substantially pure CO₂ stream that could be further processed to produce a sequestration ready CO₂ stream. The NH₃ and H₂O are returned to the regenerated potassium carbonate solution and fed back into the scrubber.

Experiments have shown there are acceptable ranges of concentrations and acidity of the carbonate/bicarbonate solution to carry out the process of the present invention. It has been found that an acceptable range of carbonate/bicarbonate concentration is 5 to 20 wt %, ammonium is 0.1 to 3 wt % and alkali is 4 to 25 wt %. The solution would have a pH between 8.5 and 12.

Experiments have also shown optimum ranges of concentrations and acidity of the carbonate/bicarbonate solution. The optimum carbonate/bicarbonate concentration of 7 to 8 wt %, ammonium of 0.20 to 0.25 wt %, and potassium of 7 to 8 wt %. The optimum pH range is between 10 and 10.5.

Some advantages of using a mixed alkali system include:
1. Lower ammonia vapor pressures for solutions with the same capacity compared to ammonium carbonate solutions
2. Higher rate of CO₂ hydration and therefore requirements for smaller mass transfer devices compared to sodium or potassium carbonate scrubbing solutions.
3. Higher carbonate concentrations for a given pH can be run compared to ammonium carbonate solutions improving the capacity of the solution.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. A process for removing CO₂ from a gas stream that minimizes NH₃ loss and regeneration energy yet maintains a high rate of CO₂ removal comprising the steps of:
providing a flue gas stream comprising CO₂;
providing a carbonate/bicarbonate solution also comprising ammonium and at least one alkali;
absorbing CO₂ from the flue gas stream into the carbonate/bicarbonate solution thereby producing additional carbonate/bicarbonate; and
regenerating the carbonate/bicarbonate solution by heating the solution to release CO₂.

2. The process of claim 1, wherein the alkali is sodium or potassium.

3. The process of claim 1, wherein the carbonate/bicarbonate solution has carbonate/bicarbonate at a concentration of 5 to 20 wt %, ammonium at a concentration of 0.1 to 3 wt %, and alkali at a concentration of 4 to 25 wt %.

4. The process of claim 3 where the pH of the carbonate/bicarbonate solution is between 8.5 and 12.

5. The process of claim 2, wherein the carbonate/bicarbonate solution has carbonate/bicarbonate at a concentration of 7 to 8 wt %, ammonium at a concentration of 0.20 to 0.25 wt %, and potassium at a concentration of 7 to 8 wt %.

6. The process of claim 5, wherein the pH of the carbonate/bicarbonate solution more preferably is between 10 and 10.5.

7. The process of claim 3, further comprising the step of controlling the concentration of ammonium in the carbonate/bicarbonate solution to make up for ammonia vapor that is lost from the process.

8. The process of claim 1 further comprising the step of providing a CO₂ mass transfer section for absorbing the CO₂ from the flue gas stream.

9. The process of claim 1 further comprising the step of removing SO₂, particulate matter, and any aerosols present in the flue gas stream before the CO₂ absorbing step.

10. The process of claim 9, wherein removing particulate matter and any aerosols is done with a wet electrostatic precipitator.

11. The process of claim 1, wherein the regenerating step also releases NH₃ and H₂O from carbonate/bicarbonate solution in addition to the CO₂.

12. The process of claim 11 further comprising the step of returning the released NH₃ and H₂O to the carbonate/bicarbonate solution.

13. The process of claim 11 further comprising the step of separating CO₂ from the released NH₃ and H₂O.

14. A scrubbing tower apparatus for removing CO₂ from a gas stream that minimizes NH₃ loss and regeneration energy yet maintains a high rate of CO₂ removal comprising:
an ammonium capture section;
a CO₂ capture section;
a wet electrostatic precipitator section; and
a mass transfer section.
